(19) United States
(12) Patent Application Publication
(10) Pub. No.: US 2008/0252193 A1
(43) Pub. Date: Oct. 16, 2008

(54) Fluorescent Lamp, Backlight Unit and Liquid Crystal Television

(76) Inventors: Kenji Yamada, Kyoto (JP); Taizou Ono, Osaka (JP); Hiroyuki Arata, Hyogo (JP); Hideki Wada, Osaka (JP); Kazuhiro Matsuo, Osaka (JP); Tomokazu Matsuura, Osaka (JP); Toshihiro Terada, Hyogo (JP)

Correspondence Address: SNELL & WILMER L.L.P. (Matsushita), 600 ANTON BOULEVARD, SUITE 1400, COSTA MESA, CA, 92626, US

(21) Appl. No.: 11/910,033

(22) PCT Filed: May 22, 2006
(86) PCT No.: PCT/JP2006/310117

§ 371 Date: Sep. 28, 2007

(30) Foreign Application Priority Data
May 31, 2005 (JP) 2005-158728
Aug. 18, 2005 (JP) 2005-237177
Aug. 18, 2005 (JP) 2005-237178
Dec. 14, 2005 (JP) 2005-359956

(51) Int. Cl. H01J 63/04; H01J 17/20

(52) U.S. Cl. 313/486; 313/642

(57) ABSTRACT

The present invention relates to a fluorescent lamp, and in particular to a fluorescent lamp with an improved in-dark starting characteristic. A fluorescent lamp includes: a glass bulb (101) having a discharge space therein; two external electrodes (102 and 103) provided at both ends of the glass bulb; and a phosphor layer (106) provided on an inner surface of the glass bulb. The glass bulb is made of glass that contains 3% to 20% inclusive of sodium oxide. The phosphor layer includes phosphor particles (106R and 106G) containing no alumina and phosphor particles (106B) containing alumina. A metal oxide (107) is attached to surfaces of the phosphor particles containing alumina. Sodium oxide precipitated on the inner surface of the glass bulb improves the in-dark starting characteristic. The phosphor particles containing alumina are protected by the metal oxide for being susceptible to deterioration due to reaction thereof with sodium oxide.

### TECHNICAL FIELD

The present invention relates to a fluorescent lamp having a tube-shaped glass bulb whose both ends are provided with electrodes, a backlight unit, and a liquid crystal television.

### BACKGROUND ART

As a display of the liquid crystal television has become larger in recent years, there has been increasing demand for a backlight unit designed for a large-screen liquid crystal television. Examples of lamps that have been practically used for the backlight unit include a fluorescent lamp having a glass bulb that includes electrodes mounted outside the glass bulb (i.e., an external electrode fluorescent lamp), and a fluorescent lamp having a glass bulb that includes electrodes mounted inside the glass bulb (i.e., a cold cathode fluorescent lamp).

In darkness, these fluorescent lamps do not operate instantly after a starting voltage is applied thereto; it takes a while for them to give off light. In other words, the above fluorescent lamps have poor in-dark starting characteristics. In order to improve such characteristics from a technological perspective, it has been proposed to apply, to inner surfaces of end portions of the glass bulbs, an electron-emitting material having a high secondary electron emission coefficient, such as acesium compound. According to this technology, the applied cesium compound emits secondary electrons that make a discharge likely to occur when the fluorescent lamps are getting initiated for operation, and this will improve the in-dark starting characteristics of the fluorescent lamps.

This application of the present invention relates to the prior art disclosed in several documents, one example of which is Patent Document 1.

### Patent Document 1:

### Japanese Laid-Open Patent Application No. 2003-36815

### DISCLOSURE OF THE INVENTION

### The Problems the Invention is Going to Solve

However, having examined the aforementioned technology, inventors of the present invention have found a problem pertaining thereto: at an early stage of lamp life, the cesium compound near a light-emitting area (an area emitting visible light from the glass bulb) may, over time, reduce luminous flux generated by the fluorescent lamp during operation.

That is, due to a discharge that accompanies lighting of the lamp, cesium is released from the cesium compound applied to the inner, near-electrode surface of the glass bulb. The released cesium scatters, attaching to a phosphor layer of the aforementioned light-emitting area. As cesium is yellow and has a low translucency, the phosphor layer with the cesium attached thereto will naturally end up in having a lower translucency. At the early stage of lamp life, this will, over time, reduce luminous flux generated by the lamp during operation.

In addition to the time-proportional decrease in the luminous flux, the inventors have also discovered from the examination that a chromaticity shift occurs in the lamp—that is, chromaticity of the lamp strays from a designed value. This chromaticity shift problem should be resolved as soon as possible, because the chromaticity shift in the lamp used as a backlight will trigger a chromaticity shift in the backlight, and further has a detrimental effect on chromaticity of a display of a liquid crystal television.

In light of the above problems, the present invention aims to provide (i) a fluorescent lamp that has a great in-dark starting characteristic and prevents the time-proportional decrease in the luminous flux it generates, (ii) a backlight unit and (iii) a liquid crystal television.

### Means to Solve the Problems

In order to achieve the above aim, the present invention provides a fluorescent lamp, comprising: a glass bulb having a discharge space therein two electrodes each of which is provided at a different end of the glass bulb; and a phosphor layer that includes phosphor particles and is provided, either directly or indirectly, on an inner surface of the glass bulb, wherein the glass bulb is made of glass that contains 3% to 20% inclusive of sodium oxide, the phosphor particles included in the phosphor layer are composed of alumina-containing phosphor particles that contain alumina and alumina-free phosphor particles that contain no alumina, and each of the alumina-containing phosphor particles has a larger surface area to which a metal oxide has been attached than each of the alumina-free phosphor particles.

According to the above structure, a given amount of sodium oxide contained in the glass bulb improves the in-dark starting characteristic of the lamp. Also, each of the alumina-containing phosphor particles has a larger surface area to which the metal oxide has been attached than each of the alumina-free phosphor particles. It is thus possible to effectively suppress the mercury attaching to the deterioration-prone alumina-containing phosphor particles, and to prevent the time-proportional decrease in luminous flux generated by the lamp, as well as the chromaticity shift in the lamp.

The present invention also provides the fluorescent lamp further comprising a protective layer that is provided on the inner surface of the glass bulb, wherein the phosphor layer is provided on the protective layer, and the inner surface of the glass bulb has, at each end of the glass bulb, an area that is not covered by the protective layer and is thus exposed to the discharge space.

As the given amount of sodium oxide is contained in the glass in the above structure, in the discharge space, the sodium oxide exists in the area that is not covered by the protective layer. The sodium oxide in such an area is exposed to the discharge space, and thereby is able to remarkably improve the in-dark starting characteristic of the lamp.

In the above fluorescent lamp, in the area of the inner surface of the glass bulb, the sodium oxide deposited from the glass exists.

In the above fluorescent lamp, the protective layer contains at least one of Y₂O₃, MgO, La₂O₃, and SiO₂.

In the above fluorescent lamp, the phosphor layer is provided between inward ends of the electrodes, the inward ends being closer to a center of the glass bulb than other ends of the electrodes, while the protective layer is provided between outward ends of the electrodes, the outward ends being farther from the center of the glass bulb than the inward ends of the electrodes.

In the above fluorescent lamp, the glass bulb contains 5% to 20% inclusive of sodium oxide.

In the above fluorescent lamp, the metal oxide has been attached only to surfaces of the alumina-containing phosphor particles, and not to surfaces of the alumina-free phosphor particles.

In the above fluorescent lamp, the metal oxide contains at least one of Y₂O₃, MgO, La₂O₃, and SiO₂.

In the above fluorescent lamp, the metal oxide composes 0.1 wt % or more of a total weight composition of the phosphor particles included in the phosphor layer.

In the above fluorescent lamp, the electrodes are external electrodes each of which is provided at the different end of the glass bulb on an outer surface thereof.

In the above fluorescent lamp, the external electrodes are constituted by any one of solder, a silver paste, a nickel paste, a gold paste, a palladium paste, and a carbon paste.

The present invention also provides the above fluorescent lamp further comprising two metal portions each of which has been connected to each of the external electrodes by covering at least part of outer surfaces of the external electrodes, wherein the metal portions cover the external electrodes in such a way that inward ends of the external electrodes extend farther towards the center of the glass bulb by a given distance than inward ends of the metal portions, the inward ends of the external electrodes being closer to the center of the glass bulb than other ends of the external electrodes, and the inward ends of the metal portions being closer to the center of the glass bulb than other ends of the metal portions.

In the above fluorescent lamp, the inward ends of the metal portions have been chamfered.

In the above fluorescent lamp, a slit is provided to each of the metal portions in a longitudinal direction, and the metal portions have been connected to the external electrodes by elasticity thereof.

The present invention also provides the above fluorescent lamp further comprising a protective layer that is provided on the inner surface of the glass bulb at least in areas corresponding to the external electrodes, wherein the protective layer is an aggregate of metal oxide particles and has an average thickness of 2 μm or less and a surface roughness of 1 μm or less.

In the above fluorescent lamp, at least part of the outer surface of the glass bulb has been roughened, each of the external electrodes includes a conductive layer that is provided on the roughened surface of the glass bulb, and the conductive layer has a maximum thickness of 70 μm or less and is thinner towards the center of the glass bulb such that an inward end of the conductive layer draws a gentle arc projecting outwardly, the inward end of the conductive layer being closer to the center of the glass bulb than other end of the conductive layer.

In the above fluorescent lamp, each of the external electrodes includes: an electrode body layer that is provided on the roughened surface of the glass bulb and contains silver or copper as a primary component thereof; and a coating layer that is provided on an outer surface of the electrode body layer. Also in the above fluorescent lamp, each of the external electrodes has a maximum thickness of 70 μm or less and is thinner towards the center of the glass bulb.

In the above fluorescent lamp, the conductive layer is thinner towards the center of the glass bulb such that an inward end of the conductive layer draws a gentle arc projecting outwardly, the inward end of the conductive layer being closer to the center of the glass bulb than other end of the conductive layer.

The present invention further provides a backlight unit including the above fluorescent lamp as a light source.

The present invention yet further provides a liquid crystal television including the above backlight unit.

Note that the “fluorescent lamp” of the present invention is intended to include, at least, (i) an external electrode fluorescent lamp having a glass bulb that includes electrodes mounted outside the glass bulb and (ii) a cold cathode fluorescent lamp having a glass bulb that includes cold cathode electrodes mounted inside the glass bulb.

Also note that the “alumina-containing phosphor particles” refer to phosphor particles expressed by a chemical formula including Al_{X}O_{Y}, whereas the “alumina-free phosphor particles” refer to phosphor particles expressed by a chemical formula that does not include Al_{X}O_{Y}.

### BRIEF DESCRIPTION OF THE DRAWINGS

FIG. 1 shows an overview of a liquid crystal television pertaining to a first embodiment of the present invention.

FIG. 2 shows an overview of a socket board 50 pertaining to the first embodiment of the present invention.

FIG. 3A shows an overview of an external electrode fluorescent lamp 100 pertaining to the first embodiment, and

FIG. 3B shows an external view of a metal portion 104.

FIG. 4 shows changes in a chromaticity shift depending on a concentration of metal oxide in phosphors.

FIG. 5 shows changes in luminance of a lamp depending on a concentration of metal oxide in phosphors.

FIG. 6 schematically shows phosphors contained in a phosphor layer.

FIG. 7 shows an overview of an external electrode fluorescent lamp 200 pertaining to a second embodiment.

FIG. 8 shows an overview of an external electrode fluorescent lamp 400 pertaining to modification 1 of the second embodiment.

FIG. 9 shows an overview of an external electrode fluorescent lamp 420 pertaining to modification 2 of the second embodiment.

FIG. 10 shows an overview of a cold cathode fluorescent lamp 300 pertaining to a third embodiment.

### DESCRIPTION OF CHARACTERS

100, 200 fluorescent lamp
101 glass bulb
102, 103 external electrode
106 phosphor layer
106R, 106G alumina-free phosphor particles
106B alumina-containing phosphor particles
107 metal oxide
300 cold cathode fluorescent lamp
302, 303 electrode

### BEST MODE FOR CARRYING OUT THE INVENTION

### First Embodiment

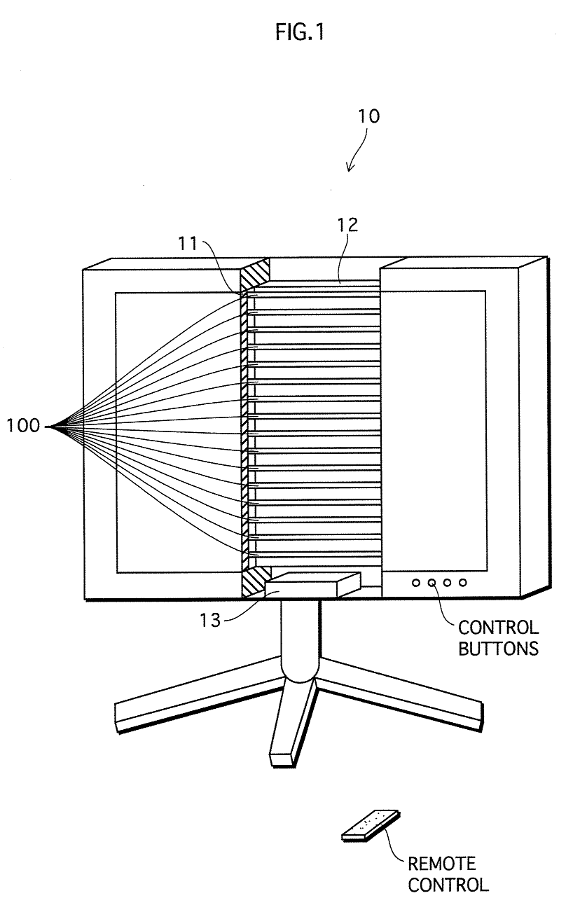

FIG. 1 shows an overview of a liquid crystal television pertaining to a first embodiment of the present invention.

A liquid crystal television 10 shown in FIG. 1 is, for example, a 32-inch liquid crystal television, and includes a liquid crystal display unit 11 and a backlight unit 12.

The liquid crystal display unit 11 is composed of a color filter substrate, a liquid crystal, a TFT substrate, a drive module (not illustrated) etc., and forms color images based on an external image signal.

The backlight unit 12 is an LCBL unit and composed of one high-frequency electronic ballast 13 and sixteen dielectric barrier discharge lamps 100 (hereafter, simply “fluorescent lamp 100”).

The high-frequency electronic ballast 13 is a lighting circuit that operates all of the sixteen fluorescent lamps 100.

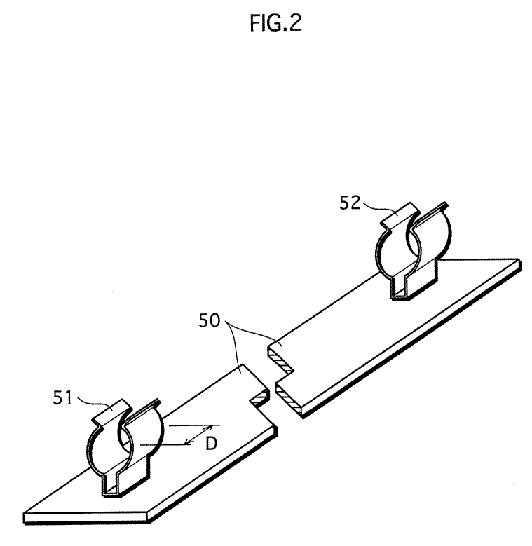

A socket board 50 shown in FIG. 2 has electrode sockets 51 and 52 made of elastic stainless steel, phosphor bronze, etc. The electrode sockets 51 and 52 hold both end portions of each of the sixteen fluorescent lamps 100 so that these lamps can be operated. Holding portions of the electrode sockets 51 and 52 are each designed to have a width D, such that the holding portions can hold each lamp by its external electrodes 102 and 103 that will be explained later. This is for suppressing an occurrence of a corona discharge during lamp operation.

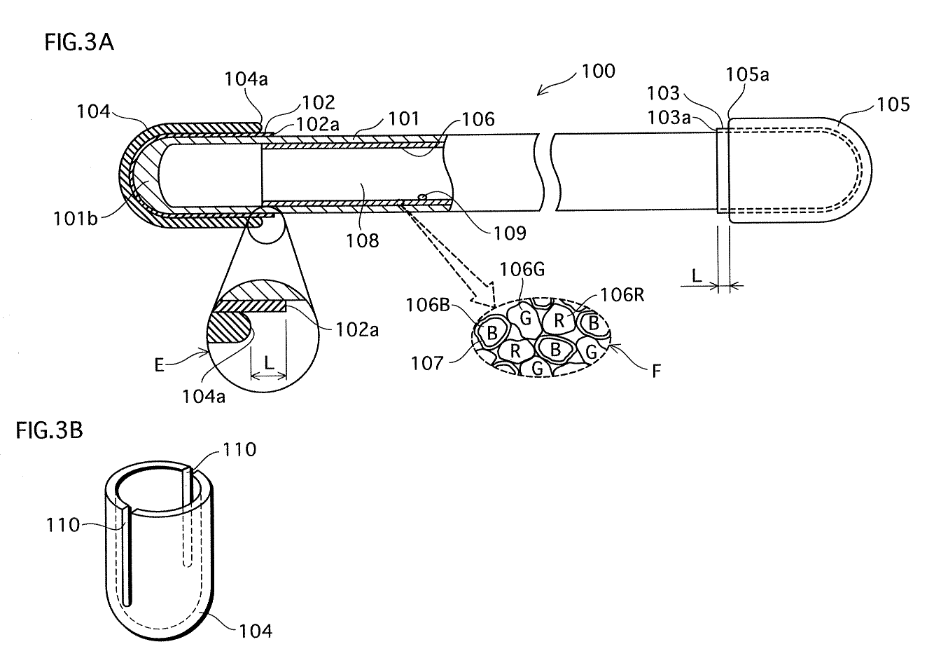

FIG. 3A shows an overview of the fluorescent lamp 100 pertaining to the first embodiment of the present invention.

As shown in FIG. 3A, the fluorescent lamp 100 pertaining to the first embodiment of the present invention has a tube-shaped glass bulb 101.

Cap-shaped external electrodes 102 and 103 are provided, as conductive layers, around outer circumferences of the end portions of the glass bulb 101.

Cap-shaped metal portions 104 and 105 are provided around outer circumferences of the external electrodes 102 and 103, in such a way that the metal portions 104 and 105 cover the external electrodes 102 and 103.

The metal portions 104 and 105 can be made by any material that has a high electric conductivity and a thermal expansion coefficient close to that of the glass bulb 101. One example of such a material is Fe—Ni—Co (Kovar).

As shown in an enlarged view E in FIG. 3A, the metal portions 104 and 105 do not cover the entire external electrodes 102 and 103. Electrode ends 102a and 103a of the external electrodes 102 and 103 lay bare. Here, the electrode ends 102a and 103a are parts of the external electrodes 102 and 103 that are closest to the center of the glass bulb (parts that are near the openings of the external electrodes 102 and 103).

A distance L between (i) the electrode end 102a (103a) of the external electrode 102 (103) that is closest to the center of the glass bulb and (ii) an edge 104a (105a) of the metal portion 104 (105) that is closest to the center of the glass bulb is, for example, 1 mm.

When viewed in a direction perpendicular to a tube axis, the glass bulb 101 has a cross section in the shape of an approximate circle.

A phosphor layer 106 is provided on an inner surface of the glass bulb 101 by application and sintering of rare earth phosphors, which are a mixture of red (Y₂O₃:Eu³⁺), green (LaPO₄:Ce³⁺, Tb³⁺) and blue (BaMg₂Al₁₆O₂₇:Eu²⁺) phosphors.

The phosphor layer 106 has a thickness of approximately 20 μm and is provided on the inner surface of the glass bulb 101 only between the external electrodes 102 and 103 (i.e., between areas that correspond to the external electrodes 102 and 103).

In the present embodiment, as shown in an enlarged view F in FIG. 3A, yttrium oxide (Y₂O₃) is coated, as a metal oxide 107, on surfaces of blue phosphor particles 106B (BaMg₂Al₁₆O₂₇:Eu²⁺) contained in the phosphor layer 106.

As red, green and blue phosphor particles are mixed in the manufacturing process, the metal oxide coatings on the surfaces of the blue phosphor particles 106B may attach to the surrounding red phosphor particles 106R and green phosphor particles 106G that are in direct contact with the blue phosphor particles 106B.

It is permissible to apply the metal oxide coatings on the surfaces of the red and green phosphor particles 106R and 106G as well from the beginning.

The glass bulb 101 is filled with (i) rare gas 108 such as argon and neon at a pressure of approximately 8 kPa and (ii) approximately 2 mg of mercury 109. The rare gas 108, which is a discharge medium, is filled into the glass bulb 101 in a reduced pressure state.

The glass bulb 101 is a discharge vessel and is made of, for example, soda glass that contains 16 (%) of sodium oxide. In the present embodiment, the glass bulb 101 is a straight glass bulb having a total length of 720 mm, an outer diameter of 4.0 mm, and an inner diameter of 3.0 mm.

FIG. 3B shows an external view of the metal portion 104.

The metal portions 104 and 105 are the same. The metal portion 104 is a cylinder with one opening thereof covered by a hemispherical dome (i.e., the metal portion 104 is cap-shaped). To elasticize the metal portion 104, for example, two slits 110 are provided thereto in a longitudinal direction. The two slits 110 give elasticity to the metal portion 104, so that the metal portion 104 stays connected to the external electrode 120.

The metal portion 104 is attached to the glass bulb 101 from one end portion of the glass bulb 101b toward the center of the glass bulb. As shown in the enlarged view E in FIG. 3A, the edge 104a of the metal portion 104, the edge closest to the center of the glass bulb 101, has been chamfered such that the metal portion 104 does not have a sharp edge. This makes it easy to attach the metal portion 104 to the glass bulb 101 from the end portion thereof. Consequently, outer surfaces of the external electrodes 102 and 103 are less likely to get damaged from the attaching of the metal portion 104.

For reducing the damages made to the outer surfaces of the external electrodes 102 and 103, the metal portions 104 and 105 should not be made of materials with plasticity (e.g., metal foils and metal tapes) that are not solid, undergo deformation when an external force is applied, and remains deformed after the external force has been removed. Instead, it is preferable that the metal portions 104 and 105 have solid shapes with no plasticity such that the metal portions 104 and 105 do not easily undergo deformation when the external force is applied.

In the present embodiment, the metal portions 104 and 105 each have, for example, a total length of 23.0 mm, an outer diameter of 4.5 mm, an inner diameter of 4.1 mm and a wall-thickness of 0.2 mm. Unlike the metal foils and metal tapes, the metal portions 104 and 105 do not have plasticity. The metal portions 104 and 105, therefore, can be designed to have a thickness with which they do not get scratches.

Here, as the glass bulb 101 has the outer diameter of 4.0 mm and the inner diameter of 3.0 mm, while the metal portions 104 and 105 have the inner diameter of 4.1 mm, a gap between the glass bulb 101 and the metal portions 104 and 105 is 0.05 mm on average.

The external electrodes 102 and 103 are provided in advance by applying, by a dipping method, a conductive paste (e.g., a silver paste) around entire circumferences of the end portions of the sealed glass bulb 101, such that the applied conductive paste has a certain total width (e.g., 25.0 mm) starting from each tip of the glass bulb 101.

The conductive paste forming the external electrodes 102 and 103 is not limited to the silver paste, but may be a nickel paste, a gold paste, a palladium paste, or a carbon paste.

Considering that the conductive paste forming the external electrodes 102 and 103 is highly adhesive to the outer surface of the glass bulb 101, it is preferable for the conductive paste to contain a low-melting glass as a binder. Desirably, the conductive paste contains 1 (wt %) to 10 (wt %) inclusive of the low-melting glass, and the low-melting glass has a resistivity of about 10⁻¹ Ωcm to 10⁻⁶ Ωcm.

The glass bulb 101 of the present invention is made of, but not limited to, the soda glass that contains 16 (%) of sodium oxide (Na₂O) as described earlier in the present embodiment.

In other words, in the present invention, sodium oxide is deposited from the glass that composes the glass bulb, the deposited sodium oxide improving the in-dark characteristic of the lamp. From this point of view, the glass bulb 101 may be composed of any glass as long as the glass produces enough sodium oxide depositions to improve the in-dark starting characteristic.

Taking the workability of the glass into consideration, it is desirable for the glass to contain a 3 (%) to 20 (%) inclusive range of sodium oxide. If the glass contains 5 (%) or more of sodium oxide, an in-dark starting time in darkness becomes about one second or less. On the other hand, if the glass contains more than 20 (%) of sodium oxide, several disadvantages occur including the following: (i) the glass bulb whitens after long hours of operation, reducing the luminance of the lamp; and (ii) the glass bulb 101 loses its strength. In terms of environmental friendliness, it is preferable to use soda glass that contains (i) the above percentage range of alkaline metal and (ii) 0.1 (%) or less of lead (i.e., a “lead-free glass”), or more preferably 0.01 (%) or less of lead.

The glass bulb is made of, but not limited to, soda glass. Any glass other than the soda glass can improve the aforementioned in-dark starting characteristic, as long as the glass contains the above percentage range of sodium oxide.

In the present embodiment, yttrium oxide (Y₂O₃) is coated, as the metal oxide 107, on the surfaces of the blue phosphor particles 106B (BaMg₂Al₁₆O₂₇:Eu²⁺), but is not limited as such. Instead, the metal oxide 107 may contain at least one of Y₂O₃, MgO, La₂O₃ and SiO₂. Especially, Y₂O₃ has a characteristic of reflecting ultraviolet radiation. With Y₂O₃, it is possible to enhance energy use efficiency by getting the ultraviolet radiation reflected toward inside the glass bulb, and consequently to increase the luminous flux.

Although the glass bulb 101 has been described to have an outer diameter of 4.0 mm and an inner diameter of 3.0 mm in the present embodiment, the inner diameter of the glass bulb may be larger than 3.0 mm. However, for the purpose of reducing the depth of backlight units and of providing the best lamp efficiency, it is preferable for the glass bulb 101 to have an inner diameter of 3.0 mm or less. As for the lower limit, considering the manufacturing difficulty, it is preferable for the glass bulb 101 to have an inner diameter of 1.0 mm or more.

In the present embodiment, the glass bulb 101 has been described to have a cross section in the shape of a circle, but is not limited to such. Instead, the glass bulb 101 may have a cross section in the shape of an ellipse, a race track, or the like.

In the present embodiment, the external electrodes 102 and 103 and the metal portions 104 and 105 have been described to be cap-shaped, but are not limited to such. For example, while the external electrodes 102 and 103 are cap-shaped, the metal portions 104 and 105 may be in the shapes of hollow cylinders (cylinders having their both ends open), so that the metal portions 104 and 105 can cover the external electrodes 102 and 103.

In the present embodiment, the fluorescent lamp 100 has been described to have a straight tube, but is not limited to such. Instead, the fluorescent lamp 100 may be U-shaped, W-shaped, etc.

As shown in FIG. 1, the backlight unit has been described to be a direct-type backlight unit in the present embodiment. However, the lamp of the present invention may be used as a light source for an edge-type backlight unit.

The following describes effects obtained by operating the aforementioned fluorescent lamp 100, the backlight unit 12, and the liquid crystal television 10 of the present invention.

As sodium oxide is contained in the soda glass of the present embodiment, sodium oxide exists on the surface of the glass bulb 101, the surface that is in direct contact with the discharge space.

Especially the sodium oxide near the external electrodes 102 and 103 can improve the in-dark starting characteristic. Moreover, unlike the structure explained in the background art section, the glass bulb of the present embodiment does not contain cesium compound inside thereof near the electrodes. This prevents cesium-triggered yellowing of the glass and suppresses time-proportional decrease in the luminous flux during lamp operation. Note that a radioactive material, such as cesium, may be provided to inner surfaces of end portions of the glass bulb 101, since it is considered that, in the end portions of the glass bulb 101, little radioactive material is scattered toward the light-emitting area.

Each of the alumina-containing phosphor particles 106B has a larger surface area to which the metal oxide is attached than each of the alumina-free phosphor particles 106R and 106G. Here, the metal oxide 107 is attached to part of, or the entire surfaces of the alumina-containing phosphor particles 106B. In other words, the metal oxide 107 forms protective layers on the surfaces of the alumina-containing phosphor particles 106B.

The alumina-containing phosphor particles 106B is susceptible to deterioration due to (i) the mercury attaching thereto and (ii) its reaction with sodium oxide.

The above structure can effectively suppress the mercury attaching to the alumina-containing phosphor particles. The decrease in the luminous flux during lamp operation can be accordingly suppressed. The above structure can further suppress the reaction between the sodium oxide deposited from the soda glass and the alumina-containing phosphor particles 106B. It is thereby possible to prevent a chromaticity shift in a lamp light, which is caused by the reaction-triggered deterioration of the alumina-containing phosphor particles 106B.

Also, reducing the metal oxide that relatively attaches to the alumina-free phosphor particles, which are resistant to deterioration compared to the alumina-containing phosphor particles, prevents the decrease in the luminous flux generated by the lamp caused by the metal oxide attaching to the alumina-free phosphor particles.

The aforementioned, reaction-triggered chromaticity shift in the lamp light can be further prevented by having the phosphors of the phosphor layer 106 contain, preferably, 0.1 wt % or more of metal oxide. The reasons of which are explained below.

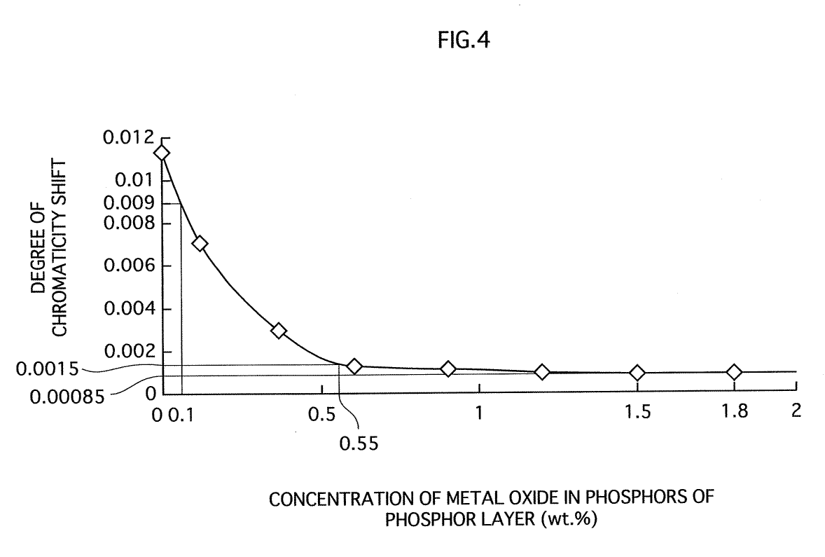

In a graph shown in FIG. 4, a horizontal axis represents a concentration (wt %) of sodium oxide in phosphors of the phosphor layer 106, while a vertical axis represents a degree of a chromaticity shift.

Here, the chromaticity shift means how an actual value defined by CIE chromaticity coordinates (x1, y1) is shifted from a desired value (a designed value).

Given that CIE chromaticity coordinates of the desired value are (x0, y0), the degree of the chromaticity shift is expressed by the following formula: (Δx²+Δy²)^{1/2} (note: Δx=x0−x1, Δy=y0−y1).

The inventors of the present invention examined how the chromaticity shift in the lamp light visually affects a liquid crystal display, both directly and indirectly. As a result, the inventors have found out that the lamp turns yellowish when the degree of the chromaticity shift (Δx²+Δy²)^{1/2} exceeds 0.01. Therefore, using the lamp as, for example, a backlight for a liquid crystal display apparatus is undesirable, as the lamp has a detrimental effect on the colors reproduced on the liquid crystal display.

As shown in FIG. 4, when the concentration of the metal oxide in the phosphors of the phosphor layer 106 is 0.1 wt %, the degree of the chromaticity shift (Δx²+Δy²)^{1/2} is 0.009. Based on the above finding, it is apparent that the chromaticity shift in the lamp light is prevented when the actual value is expressed by these coordinates.

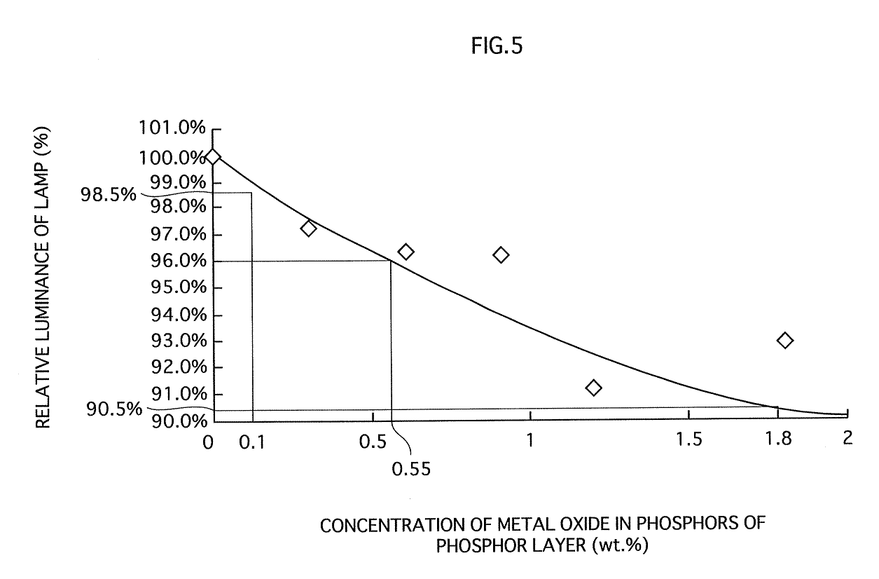

However, it is also apparent from FIG. 4 that although the degree of the chromaticity shift decreases as the concentration of metal oxide in the phosphors of the phosphor layer 106 increases, once the concentration hits a certain point, the degree of the chromaticity shift barely changes. Moreover, as shown in FIG. 5, it has been found that as the concentration of metal oxide in the phosphors of the phosphor layer 106 increases, relative luminance of the lamp decreases gradually.

Note that in a graph shown in FIG. 5, a horizontal axis represents a concentration (wt %) of metal oxide in the phosphors of the phosphor layer 106, while a vertical axis represents the relative luminance (%) of the lamp.

As referred to herein the term “the relative luminance of the lamp” means a ratio of initial luminance of the lamp with the aforementioned concentration of the metal oxide to that of the lamp containing 0 wt % metal oxide, with the latter being regarded as 100% (the initial luminance means the luminance of the lamp at the beginning of operation, e.g., when 0 hour has passed since the lamp has been operated).

It has been found that when the relative luminance of the lamp is 90% or lower, the lamp light becomes darker. Consequently, it is undesirable to use the lamp as, for example, a backlight for a liquid crystal apparatus, because the lamp darkens a display of the liquid crystal apparatus.

As is apparent from FIG. 5, if the concentration of metal oxide is 1.8 wt % or less, the relative luminance of the lamp stays 90.5% or above.

When the aforementioned concentration is 0.55 wt %, the relative luminance of the lamp is 96.0%. With this concentration, a decrease in the luminance is within an allowable range.

It should be noted that with the concentration of metal oxide in the phosphors of the phosphor layer being 0.3 wt % to 0.9 wt % inclusive, it is possible to further reduce the chromaticity shift and suppress a decrease in the luminance.

The external electrodes 102 and 103 are provided, as the conductive layers, around outer circumferences of the ends of the glass bulb 101. The cap-shaped metal portions 104 and 105 are connected to the external electrodes 102 and 103, such that the metal portions 104 and 105 cover at least part of the outer circumferences of the external electrodes 102 and 103. The edges 104a and 105a of the metal portions 104 and 105, which are closest to the center of the glass bulb 101, and the electrode ends 102a and 103a, which are closest to the center of the glass bulb 101, are mounted in a manner that the electrode ends 102a and 103a are extended further towards the center of the glass bulb 101 by the distance L than the edges 104a and 105a. In this structure, there is no gap between the metal portions 104 and 105 and the glass bulb 101 owing to variations in the mounting of the metal portions 104 and 105. Consequently, an occurrence of a corona discharge during lamp operation is suppressed between the metal portions 104 and 105 and the glass bulb 101.

As 3 mm or more of each tip of the external electrodes 102 and 103 is covered by the metal portions 104 or 105, the metal portions 104 and 105, which are provided at the end portions of the fluorescent lamp 100, can be securely connected to and held by the electrode sockets 51 and 52 mounted on the socket board 50, so that the lamp can be operated.

Also, the edges 104a and 105a of the metal portions 104 and 105 that are closest to the center of the glass bulb 101 have been chamfered. This makes it easy to attach the metal portions 104 and 105 to the glass bulb from the end portions of the glass bulb 101. Consequently, the outer surfaces of the external electrodes 102 and 103 are less likely to get damaged from the attaching of the metal portions 104 and 105.

In order to elasticize the metal portions 104 and 105, two or more slits 110 are provided thereto in a longitudinal direction. The elasticity allows the metal portions 104 and 105 to get connected to the external electrodes 102 and 103 and makes it easy to attach the metal portions 104 and 105 to the glass bulb 101 from the end portions of the glass bulb 101. Consequently, the outer surfaces of the external electrodes 102 and 103 are less likely to get damaged from the attaching of the metal portions 104 and 105.

Using a silver paste as the conductive layer (i.e., the external electrodes 102 and 103) has the effects of improving the adhesiveness of the external electrodes 102 and 103 to the glass bulb 101, and of suppressing the occurrence of the corona discharge during lamp operation between the external electrodes 102 and 103 and the glass bulb 101. Also, it is regarded that the external electrode 102 and the glass bulb 101, which is provided between the external electrode 102 and the discharge space, together make the equivalent of a capacitor (1st capacitor), while the external electrode 103 and the glass bulb 101, which is provided between the external electrode 103 and the discharge space, together make the equivalent of another capacitor (2nd capacitor). The above structure can practically equalize the capacitance of the 1st and 2nd capacitors.

As previously described, the conductive paste forming the external electrodes 102 and 103 contains, as the binder, 1 wt % to 10 wt % inclusive of low-melting glass. This makes the outer surfaces of the external electrodes 102 and 103 less likely to get damaged when the metal portions 104 and 105 are being attached to the outer surfaces of the external electrodes 102 and 103 from the end portions of the glass bulb 101.

According to the above description, the metal oxide 107 is coated on the entire surfaces of the phosphor particles 106B. The coating style, however, is not limited to such. For example, the surfaces of the phosphor particles 106B may be attached with numerous fine particles of metal oxide.

Furthermore, not only the blue phosphor particles but also the green phosphor particles may be alumina-containing phosphor particles.

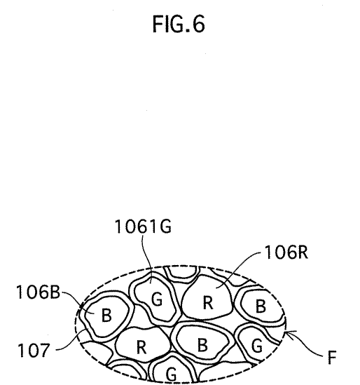

As with the enlarged view F in FIG. 3A, FIG. 6 schematically shows phosphors contained in a phosphor layer.

Green phosphor particles 1061G are composed of BaMg₂Al₁₆O₂₇:Eu²⁺, Mn²⁺ (containing alumina). Metal oxide is coated on the surfaces of alumina-containing phosphor particles 106B and 1061G.

### Second Embodiment

In the above-described first embodiment, the phosphor layer 106 is provided directly on the inner surface of the glass bulb 101. In contrast, a dielectric barrier discharge lamp pertaining to the second embodiment has a protective layer and a phosphor layer provided on an inner surface thereof in listed order.

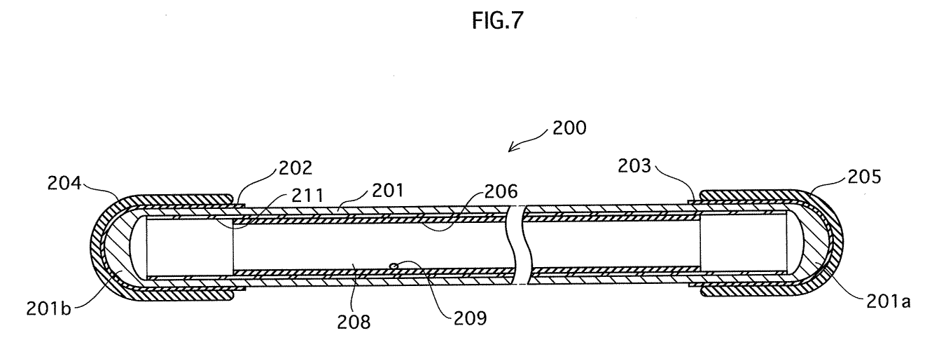

FIG. 7 shows an overview of a dielectric barrier discharge lamp 200 pertaining to the second embodiment.

The lamp 200 in FIG. 7 is constructed fundamentally the same as the fluorescent lamp 100 in FIG. 3. Although the elements shown in FIG. 3 are numbered 100s while the elements shown in FIG. 7 are numbered 200s, numbers of the corresponding elements have the same last two figures for the sake of simple explanation.

The lamp 200 has a tube-shaped glass bulb 201.

A protective layer 211 and a phosphor layer 206 are provided, in listed order, on the inner surface of the glass bulb. More specifically, the phosphor layer 206 is provided on the protective layer 211.

The protective layer 211 referred to herein contains at least one of the following metal oxides: Y₂O₃, MgO, La₂O₃ and SiO₂.

Using such a protective layer 211 containing metal oxide has the effect of (i) preventing the sodium oxide deposited from the glass bulb 201 from passing through the phosphor layer 206, (ii) efficiently restraining mercury from attaching to sodium oxide, and (iii) suppressing the time-proportional decrease in the luminous flux during lamp operation.

Note that the protective layer 211 is not provided on inner surfaces of end portions 201a and 201b of the glass bulb 201. That is, the inner surfaces of the end portions 201a and 201b lay bare and thus are in direct contact with the discharge space, resulting in the sodium oxide, which is contained in the glass bulb, improving the in-dark starting characteristic. In other words, the above structure not only yields the stated effects obtained by having the protective layer, but also improves the in-dark starting characteristic.

As shown in FIG. 7, the protective layer 211 is larger in area than the phosphor layer 206, but is not limited to such. It is permissible to provide the protective layer such that the total longitudinal length of the protective layer is approximately the same as that of the phosphor layer, or such that the phosphor layer and the inner surface of the glass bulb do not directly contact with each other (i.e., the glass bulb is kept from coming in contact with the phosphor layer by the protective layer sandwiched therebetween).

Especially in a dielectric barrier discharge lamp, mercury particles that have been ionized during lamp operation may penetrate into or collide with the inner surface of the glass bulb, opening pinholes therein. With this considered, it is preferable to provide the protective layer at least on the inner surface of the glass bulb between outward ends of the external electrodes (i.e., between areas that correspond to the outward ends of the external electrodes), or on the inner surface of the glass bulb except near both tips thereof.

### (Modification 1)

Described below is a modification example, modification 1, pertaining to the second embodiment with regard to the best characteristic of the protective layer, a shape of the outer surface of the glass bulb, and so on.

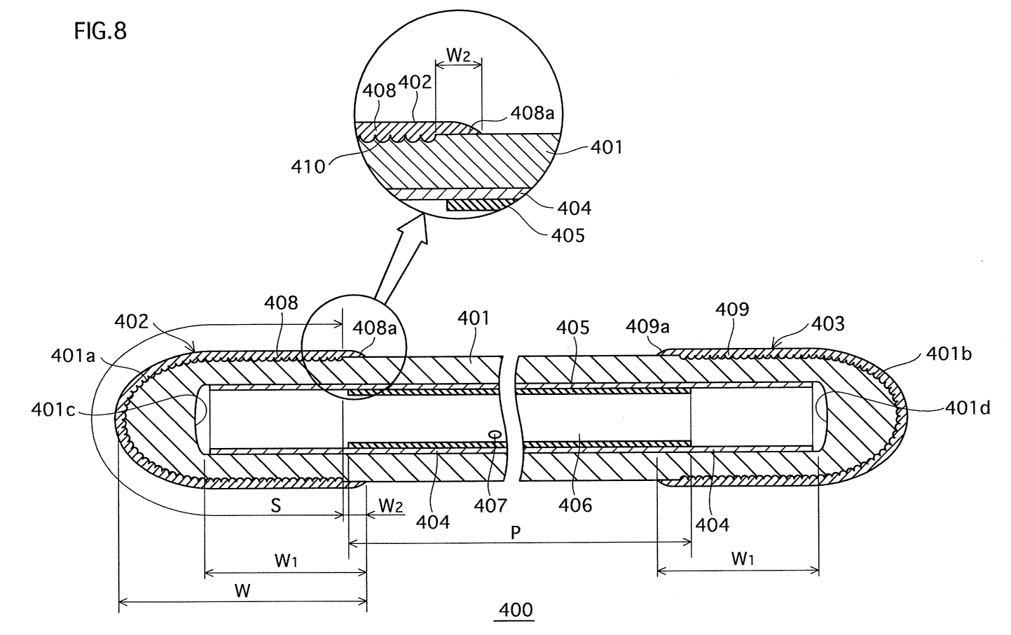

FIG. 8 shows an overview of an external electrode fluorescent lamp 400 pertaining to modification 1 of the second embodiment.

In a discharge space 406 of a glass bulb 401, mercury 407 exists as a light-emitting material.

A protective layer 404 and a phosphor layer 405 are provided on an inner surface of the glass bulb 401 in listed order.

External electrodes 402 and 403 are made by applying conductive layers 408 and 409 on outer surfaces of end portions of the glass bulb 401. These outer surfaces have been blast-treated to get roughened, are referred to as rough surfaces 401a and 401b, and have a surface roughness of 1 μm to 3 μm inclusive.

The conductive layers 408 and 409 have a maximum thickness of 70 μm or less. Layer edges 408a and 409a of the conductive layers 408 and 409 are thinner as they get closer to the center of the glass bulb 401. Outer surfaces of the layer edges 408a and 409a draw gentle arcs projecting outwardly.

In the present embodiment, the layer edges 408a and 409a of the conductive layers 408 and 409 (i) have a width W2 of 0.5 mm or more, preferably 0.5 mm to 3 mm inclusive, and (ii) are located next to the rough surfaces 401a and 401b (areas S) of the glass bulb 401.

The conductive layers 408 and 409 are made of solder whose primary component is, for example, one of (i) tin, (ii) an alloy of tin and indium and (iii) an alloy of tin and bismuth. The conductive layers 408 and 409 are provided around the entire outer circumferences of the end portions of the glass bulb 401, such that they have a certain total width W (i.e., 25 mm) starting from each tip of the glass bulb 401. Cylindrical portions of the conductive layers 408 and 409 have a width W1 of 20 mm. The conductive layers 408 and 409 are provided on the glass bulb 401 by a commonly known ultrasonic solder dipping method. With this method, the end portions of the sealed glass bulb 401 are dipped 25 mm deep into the molten solder contained in an ultrasonic solder pot, such that a 10 μm-thick solder layer is provided on the outer circumferences of the glass bulb 401.

In terms of the adhesiveness of the conductive layers 408 and 409 to the glass bulb 401, it is preferable for the aforementioned solder to contain at least one of antimony, zinc and aluminum as an additive. Furthermore, in terms of solder wettability of the aforementioned solder to the glass bulb 401, it is preferable for the solder to contain antimony, zinc, or the like as an additive. For the purpose of environmental conservation, it is preferable that the solder does not contain any environmentally unfriendly constituents such as lead.

The following describes the reasons why the layer edges 408a and 409a of the conductive layers 408 and 409 have the aforementioned width W2 of 0.5 mm to 3 mm inclusive.

In the case where the conductive layers 408 and 409 are formed by the above ultrasound solder dipping method, if the width W2 is less than 0.5 mm, the following disadvantages will occur. The outer surfaces of the layer edges 408a and 409a can hardly draw gentle arcs projecting outwardly. Instead, the layer edges 408a and 409b will be at right angles, making the corona discharge likely to occur.

On the other hand, if the width W2 exceeds 3 mm, the layer edges 408a and 409b will easily come off the outer surface of the glass bulb 401.

The protective layer 404 is made of a material that includes at least one electron emitting material such as yttrium oxide (Y₂O₃), magnesium oxide (MgO), or lanthanum oxide (La₂O₃) to be 0.5 μm (a surface roughness of 0.2 μm or less) to 2 μm (a surface roughness of 1 μm or less) inclusive in the maximum thickness as an aggregate of metal oxide particles. In the present embodiment, the protective layer 404 is made of yttrium oxide (Y₂O₃) to be 2 μm in the maximum thickness and 1 μm or less in the surface roughness as an aggregate of metal oxide particles being 0.01 μm to 0.1 μm inclusive in size.

The protective layer 404 is structured as described above to avoid the following disadvantages the inventors have confirmed. If the protective layer 404 has a maximum thickness of 2 μm and a surface roughness of more than 1 μm, the luminance of the lamp will decrease approximately 20% compared to the lamp having no protective layer—i.e., the lamp will not emit a required amount of luminance. On the other hand, if the protective layer 404 has a maximum thickness of less than 0.5 μm and a surface roughness of more than 0.2 μm, a density of the protective layer will decrease. Here, when the luminance is enhanced by, for example, increasing a drive current to 5 mA or more, argon ions and mercury ions hit an inner wall of the glass bulb 401 that is covered by the external electrodes 402 and 403. The argon ions and mercury ions erode the electrode-covered inner wall, opening holes (pinholes) therein.

In inner surfaces 401c and 401d of the end portions of the glass bulb 401, there are some areas that are not covered by the protective layer 404. With this structure, alkaline metal Na is deposited from a constituent of the glass and stays in such areas when the end portions of the glass bulb 401 are sealed.

Consequently, alkaline metal Na and metal oxide (yttrium oxide), which are electron-emitting materials, are exposed to the discharge space 406, improving the in-dark starting characteristic.

The blast-treated outer surfaces of the end portions of the glass bulb 401 and the surface roughness of the protective layer 404 conform to the “maximum height Ry” and are measured in compliance with “JIS B 0601: '94”.

Note that the external electrodes 402 and 403 do not necessarily have to be cap-shaped, but may instead be in the shapes of hollow cylinders (cylinders having their both ends open).

Also note that the external electrodes 402 and 403 may be covered by cap-shaped metal portions.

### (Modification 2)

Described below is another modification example, modification 2, pertaining to the second embodiment with regard to the structure of the external electrodes. A lamp of the present modification is fundamentally the same as the external electrode fluorescent lamp 400 that has been described with reference to FIG. 8, except that the external electrodes thereof have a different structure.

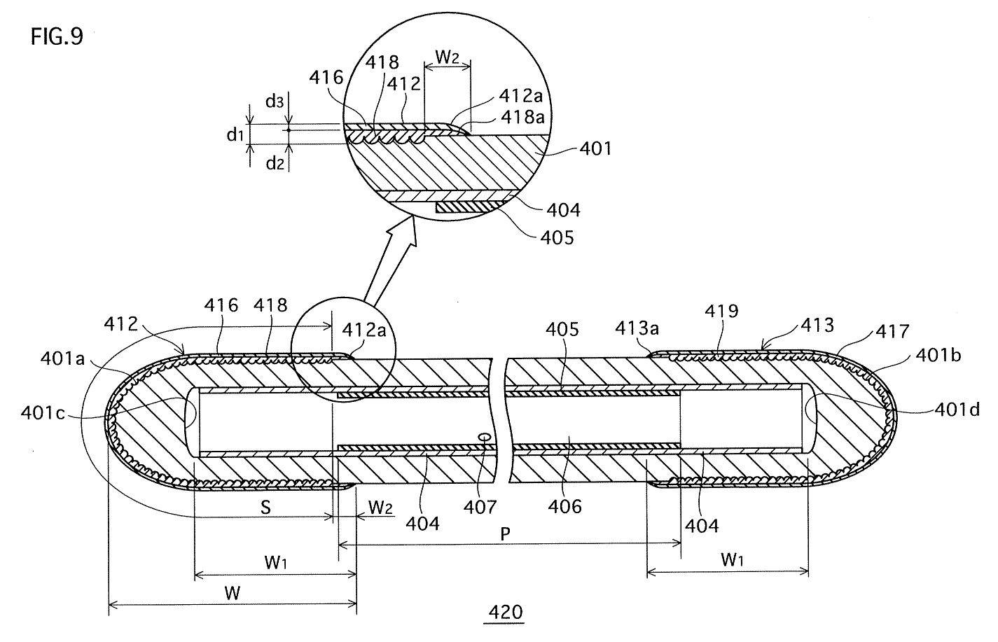

FIG. 9 shows an overview of an external electrode fluorescent lamp 420 pertaining to modification 2 of the second embodiment.

External electrodes 412 and 413 are cap-shaped and comprised of (i) electrode body layers 418 and 419 that contain silver or copper as a primary component thereof and are provided on blast-treated outer surfaces 401a and 401b of end portions of a glass bulb 401 (surface roughness of 1 μm to 3 μm inclusive), and (ii) coating layers 416 and 417 that are provided on outer surfaces of the electrode body layers 418 and 419.

The external electrodes 412 and 413 have a maximum thickness of 70 μm or less. Electrode edges 412a and 413a of the external electrodes 412 and 413 are thinner as they get closer to the center of the glass bulb 401. Outer surfaces of the electrode edges 412a and 413a draw gentle arcs projecting outwardly.

The electrode body layers 418 and 419 have a maximum thickness d2 of approximately 7 μm. In the present invention, the thickness of the electrode body layers 418 and 419 denotes a top-to-bottom measurement thereof. A primary component of the electrode body layers 418 and 419 is silver or copper; this also means that the primary component of the electrode body layers 418 and 419 may be an alloy of silver and copper. As referred to herein the term primary component means a component that is, in percentage, the largest of all the components that make up the electrode body layers 418 and 419, and therefore has a large effect on their properties. That is, the electrode body layers 418 and 419 may additionally contain a compound other than silver or copper as an additive. Furthermore, there are various ways to enhance the adhesiveness of the electrode body layers 418 and 419 to the glass bulb 401, one example of which is to add a glass frit to the electrode body layers 418 and 419. For instance, adding a glass frit that contains 1.0 wt % to 5.0 wt % inclusive of bismuth (Bi) to the electrode body layers 418 and 419 will increase their adhesiveness to the glass bulb 401 due to an anchor effect of the glass frit. Another example of the additive is ethylcellulose.

The electrode body layers 418 and 419 are provided on entire outer circumferences of the end portions of the glass bulb 401, and have a certain total width W (i.e., 25 mm) starting from each tip of the glass bulb 401. Cylindrical portions of the electrode body layers 418 and 419 have a width W1 of approximately 20 mm. The electrode body layers 418 and 419 are formed by a commonly known dipping method. With this method, the end portions of the sealed glass bulb 401 are dipped 24 mm deep into a molten silver paste pot, such that an approximately 7 μm-thick silver paste is applied on the outer circumferences of the glass bulb 401. The applied silver paste then gets sintered.

The coating layers 416 and 417 are provided on the outer surfaces of the electrode body layers 418 and 419, and have a thickness d3 of approximately 7 μm. Here, the thickness d3 of the coating layers 416 and 417 denotes a maximum thickness, namely a top-to-bottom measurement thereof.

The coating layers 416 and 417 contains, as a primary component thereof, solder that is composed of 95.2 wt % tin, 3.8 wt % silver and 1.0 wt % copper. With silver being included in the solder, the electrode body layers 418 and 419 are less prone to a silver transfer. To make the electrode body layers 418 and 419 less prone to the silver transfer, it is preferable for the solder to contain 1.0 wt % to 8.0 wt % inclusive range of silver.

The coating layers 416 and 417 can be formed by the commonly known dipping method (for example, see Japanese Laid-Open Patent Application No. 2004-146351). With this method, the end portions of the glass bulb 404, which have the electrode body layers 418 and 419 provided on the outer surfaces thereof, are dipped 25 mm deep into a molten solder pot, such that an approximately 7 μm-thick solder is applied on the outer surfaces of the electrode body layers 418 and 419. The applied solder then gets sintered.

The composition of the solder that forms the coating layers 416 and 417 is not limited to the above; instead, the solder may contain, for example, at least one of bismuth, zinc, lead, etc. However, for the purpose of environmental conservation, it is preferable that an external electrode discharge lamp does not contain any environmentally unfriendly constituents such as lead and antimony. It should be noted that the coating layers 416 and 417 may be formed by materials other than solder. For example, the coating layers 416 and 417 may be nickel layers formed by electroless planting.

In general, in the air, silver is prone to sulfurization while copper is prone to oxidization. Once silver and copper get sulfurized or oxidized, their electric resistance increases. That is to say, once the electrode body layers 418 and 419 are exposed to the air, their conductivity decreases. In contrast, in the present invention, the external electrodes 412 and 413 are formed by the electrode body layers 418 and 419 whose outer surfaces are covered by the coating layers 416 and 417. With this structure the electrode body layers 418 and 419 do not come in contact with the air. It is thereby possible to prevent the sulfurization of silver, the oxidation of copper, and the decrease in the conductivity of the external electrodes 412 and 413.

In order to prevent the sulfurization of silver and the oxidation of copper, it is preferable for the entire surfaces of the external electrodes 412 and 413 to be covered by the coating layers 416 and 417. However, as long as the conductivity of the external electrodes 412 and 413 are not strongly affected, the electrode body layers 418 and 419 may be partially exposed to the air for manufacturing or designing purposes.

Furthermore, in order to enhance the adhesiveness between the electrode body layers 418 and 419 and the coating layers 416 and 417, it is preferable that the outer surfaces of the electrode body layers, on which the coating layers 416 and 417 are provided, are polished.

### Third Embodiment

The first and second embodiments have described the dielectric barrier discharge lamp as one example of a fluorescent lamp. However, the present invention is not limited to such, but instead may be realized with use of a cold cathode fluorescent lamp. The following describes the third embodiment.

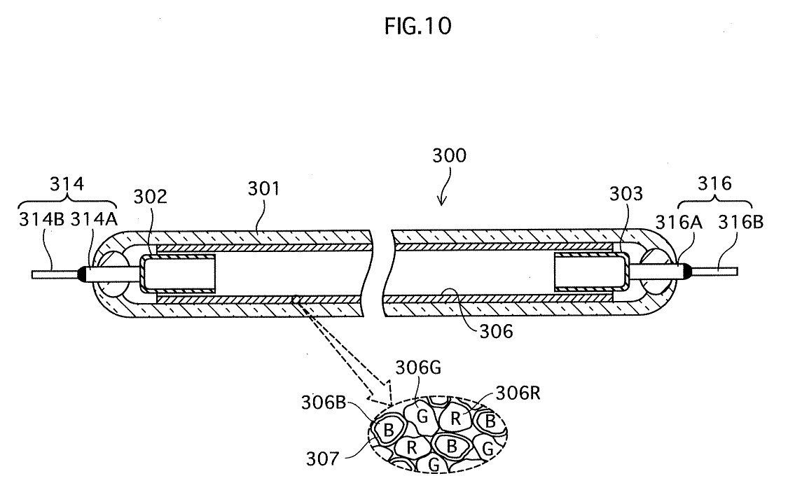

FIG. 10 shows an overview of a cold cathode fluorescent lamp 300 pertaining to the third embodiment.

The cold cathode fluorescent lamp 300 has a straight tube-shaped glass bulb 301 that is made of soda glass. The glass bulb 301, for example, has a total length of 450 mm, an outer diameter of 3.0 mm, an inner diameter of 2.0 mm, and a wall-thickness of 0.5 mm.

Leads 314 and 316 are sealed by both end portions of the glass bulb 301.

The lead 314 (316) is a wire composed of an internal lead 314A (316A) made of tungsten and an external lead 314B (316B) made of nickel. The internal leads 314A and 316A have glass containers 12. Inner surfaces of end portions of the glass containers 12 are coupled to electrodes 302 and 303 by laser welding and the like.

Each of the electrodes 302 and 303 is a so-called hollow electrode having the shape of a cylinder enclosed on one end, and is composed of niobium.

The glass bulb 301 is filled with mercury as alight-emitting material (not illustrated), and rare gas such as argon, neon, etc., at a certain pressure.

A phosphor layer 306 having a thickness of approximately 20 μm is provided on an inner surface of the glass bulb 301. The phosphor layer 306 is formed by applying a phosphor suspension on the inner surface of the glass tube, then drying and sintering the applied phosphor suspension.

As shown in an enlarged view in FIG. 10, the phosphor layer 306 contains a mixture of red phosphor particles 306R, green phosphor particles 306G and blue phosphor particles 306B.

The blue phosphor particles 306B are comprised of Eu-activated barium magnesium aluminate phosphors (BaMg₂Al₁₆O₂₇:Eu²⁺) and are alumina-containing phosphors.

Layers of metal oxide 307 cover surfaces of the blue phosphor particles 306.

### (Additional Remark)

The present invention can be realized by any combination of the above embodiments and modifications.

### INDUSTRIAL APPLICABILITY

The present invention provides, without complex processes, a lamp that has an improved in-dark starting characteristic and prevents a time-proportional decrease in luminous flux during lamp operation. The lamp of the present invention, therefore, can be widely used for a direct-type backlight unit used in a liquid crystal television, and as a document-reading light source used in office automation equipments such as a copier, a facsimile machine, an image scanner, etc. It has a great deal of potential in industry.

1. A fluorescent lamp, comprising:
a glass bulb having a discharge space therein
two electrodes each of which is provided at a different end of the glass bulb; and
a phosphor layer that includes phosphor particles and is provided, either directly or indirectly, on an inner surface of the glass bulb, wherein
the glass bulb is made of glass that contains 3 wt % to 20 wt % inclusive of sodium oxide,
the phosphor particles included in the phosphor layer are composed of alumina-containing phosphor particles that contain alumina and alumina-free phosphor particles that contain no alumina, and
each of the alumina-containing phosphor particles has a larger surface area to which a metal oxide has been attached than each of the alumina-free phosphor particles.

2. The fluorescent lamp of claim 1, further comprising:
a protective layer that is provided on the inner surface of the glass bulb, wherein
the phosphor layer is provided on the protective layer, and
the inner surface of the glass bulb has, at each end of the glass bulb, an area that is not covered by the protective layer and is thus exposed to the discharge space.

3. The fluorescent lamp of claim 2, wherein
in the area of the inner surface of the glass bulb, the sodium oxide deposited from the glass exists.

4. The fluorescent lamp of claim 2, wherein
the protective layer contains at least one of Y₂O₃, MgO, La₂O₃, and SiO₂.

5. The fluorescent lamp of claim 2, wherein
the phosphor layer is provided between inward ends of the electrodes, the inward ends being closer to a center of the glass bulb than other ends of the electrodes, and
the protective layer is provided between outward ends of the electrodes, the outward ends being farther from the center of the glass bulb than the inward ends of the electrodes.

6. The fluorescent lamp of claim 1, wherein
the glass bulb contains 5 wt % to 20 wt % inclusive of sodium oxide.

7. The fluorescent lamp of claim 1, wherein
the metal oxide has been attached only to surfaces of the alumina-containing phosphor particles, and not to surfaces of the alumina-free phosphor particles.

8. The fluorescent lamp of claim 1, wherein
the metal oxide contains at least one of Y₂O₃, MgO, La₂O₃, and SiO₂.

9. The fluorescent lamp of claim 1, wherein
the metal oxide composes 0.1 wt % or more of a total weight composition of the phosphor particles included in the phosphor layer

10. The fluorescent lamp of claim 1, wherein
the electrodes are external electrodes each of which is provided at the different end of the glass bulb on an outer surface thereof.

11. The fluorescent lamp of claim 10, wherein
the external electrodes are constituted by any one of solder, a silver paste, a nickel paste, a gold paste, a palladium paste, and a carbon paste.

12. The fluorescent lamp of claim 10. further comprising:
two metal portions each of which has been connected to each of the external electrodes, wherein
the metal protions cover the external electrodes in such a way that inward ends of the external electrodes extend farther towards the center of the glass bulb by a given distance than inward ends of the metal portions, the inward ends of the external electrodes being closer to the center of the glass bulb than other ends of the extenal electrodes. and the inward ends of the metal portions being closer to the center of the glass bulb than othr ends of the metal portions.

13. the fluorescent lamp of claim 12, wherein
the inward ends of the metal portions have been chamfered.

14. The fluorescent lamp of claim 12, wherein
a slit is provided to each of the metal portions in a longitudinal direction, and the metal portions have been connected to the external electrodes by elasticity thereof.

1. The fluorescent lamp of claim 10, further comprising:
a protective later that is provided on the inner surface of the glass bulb at least in areas corresponding to the external electrodes, wherein
the pprotective layer is aggregate of metal oxide particles and has an average thickness of 2 μm or less and a surface roughness of 1 μm or less.

16. the fluroscent lamp of claim 10, wherein
at least part of the outer surface of the glass bulb has been roughened,
each of the external electrodes includes a conductive layer thatis provided on the roughened surface of the glass bulb, and
the conductive layer has a maximum thickness of 70 μm or less and is thinner towards the center of the glass bulb such that an inward end of the conductive layer draws a gentle arc projecting outwardly, the inward end of the conductive layer being closer to the center of the glass bulb than other end of the conductive layer

17. The fluorescent lamp of claim 10, wherein
each of the external electrodes includes:
and electrode body layer that is provided on the roughened surface of the glass bulb and contains silver or copper as a primary component thereof; and
a coating layer that is provided on an outer surface of the electrode body layer, and
each of the external electrodes has a maximum thickness of 70 μm or less and is thinner towards the center of the glass bulb.

18. The fluorescent lamp of claim 17, wherein
the conductive layer is thinner towards the center of the glass bulb such that an inward end of the conductive layer draws a gentle arc projecting outwardly, the inward end of the conductive layer being closer to the center of the glass bulb than other end of the conductive layer.

19. A backlight unit, comprising:
the fluorescent lamp of claim 1 as a light source.

20. A liquid crystal television, comprising:
the backlight unit of claim 19.
